(19) United States
(12) Patent Application Publication
(10) Pub. No.: US 2017/0006992 A1
(43) Pub. Date: Jan. 12, 2017

(54) Compact, Rugged Tool and Comb Device

(71) Applicant: Caffeinate Labs, Inc., Somerville, MA (US)

(72) Inventors: Nathan Gregg Barr, Portland, ME (US); Jenna Hight, Somerville, MA (US)

(21) Appl. No.: 14/794,811

(22) Filed: Jul. 9, 2015

(51) Int. Cl. A45D 24/10; B25F 1/00; B65D 33/16

(52) U.S. Cl. CPC A45D 24/10; B65D 33/1658; B25F 1/00

(57) ABSTRACT

This invention is directed toward a compact, multifunctional tool and a method of making the compact, multifunctional tool. The embodiments disclosed include a comb and a variety of additional tools including a screwdriver, a wrench, a chip clip, a bottle opener, a retention device for storing headbands, elastics, ear buds, and the like, and a stand for propping up a mobile phone, tablet, book, magazine, and the like. The compact, multifunctional tool is preferably made of a monolithic, substantially flat body having cutouts or contours. The overall size of the compact, multifunctional tool, in a preferred embodiment, is less than the size of a standard credit card. This small size allows users to easily transport the tool in their wallet or pocket. By combining so many tools, each performing a different task, into a monolithic flat, compact body, this invention allows users to carry one small device that enables them to perform a wide variety of functions.

### CROSS-REFERENCE TO RELATED APPLICATIONS

This application claims priority to the following U.S. Provisional Patent Application: Provisional Patent Application No. 62/022650, entitled “Utility Device,” filed on Jul. 9, 2014 the entire contents of which is hereby incorporated by reference.

### Field

The present invention relates generally to a single, compact device comprising a comb and at least one additional tool such as a screwdriver, wrenches, a chip clip, a bottle opener, a storage portion, or a stand used for propping up a personal device for viewing.

### BACKGROUND

Human beings have been using combs for more than 5,000 years. In fact, combs are among the oldest tools found by archeologists, having been discovered in very refined forms from settlements dating back to 5,000 years ago. Combs come in all manner of sizes and uses, e.g., for combing human hair, pet hair, fibers, etc. They are often adorned with decorations such as jewels or carvings. A small, portable version of a comb is known as a pocket comb.

Pocket combs have the advantage of being compact, which makes them perfect for transport in one's pocket. In order for the pocket comb to withstand the various flexion forces placed on it during an average day spent in an individual's pocket, however, these combs must be designed to withstand bending that will occur by virtue of being placed in an individual's back pocket.

Viewed independently, a comb is a tool capable of performing a single function—combing. For reasons of efficiency, it is sometimes desirable to combine multiple tools into a single housing. One of the reasons why designers seek to create a single tool having more than one functionality is to reduce the number of tools an individual needs to have in order to perform more than one function. Combination tools are more efficient than having to have numerous individual tools to perform numerous functions. Moreover, combining tools into a single tool body reduces the amount of space needed to store or transport the tools.

An example of a combination tool can be found in U.S. Pat. No. 4,007,928, entitled “Golfer's Combination Tool,” which combines a shoe horn with a divot repair device. Similarly, U.S. Pat. No. 5,495,630 entitled “Dart Tool,” allows users to perform many functions associated with playing darts such as: extracting a broken dart tip from a target, tightening or loosening a connection between a dart tip and its barrel, and loosening a flight lock on the dart.

The idea of combining different functions within a comb is also known in the art. For example, U.S. Pat. No. 4,709,475, entitled “Combination Comb, Hair Trimmer, and Safety Razor,” combines several functions, which allow a user to perform hygienic maintenance functions such as hair cutting, hair styling, hair trimming, and shaving. Similarly, U.S. Pat. No. 5,884,633, entitled “Combination Comb, Brush, and Teaser Apparatus,” combines a multitude of hair styling tools into a single device. Although these combing devices provide additional functions beyond simply combing, the additional functions they facilitate are limited to personal hygiene.

It is also desirable to reduce the size of pocket combs so that they take up less space in one's pocket or wallet. In reducing the size, it is important to note that pocket combs must still maintain structural integrity so that they do not snap or bend when placed under various flexion forces as part of their normal wear and tear. In the spirit of reducing the overall size of the pocket comb, U.S. Pat. No. 4,513,842, entitled “Credit Card Hair Comb,” discloses a “hair comb sized similar to a credit card and structured to meet the flexion requirements of being housed in a wallet or credit card holder.” Id. at Abstract.

Combining the notion of a compact comb with the desirability of having a comb that can perform multiple grooming functions, U.S. Pat. No. 6,206,010, entitled “Credit Card Shaped Grooming Device,” discloses a flexible sheet approximately the size of a credit card comprising a comb, minor, nail file, and pick. Again, this multipurpose combing device is limited to performing grooming functions.

Although it is advantageous to have a single, compact comb that can perform more than one grooming task, it is desirable to have a compact comb that can perform grooming tasks, as well as additional functions, such as, tightening or loosening a screw, bolt, or nut, opening a bottle, acting as a storage space for hair bands, or being capable of being used as a stand for a personal device, such as a mobile phone or tablet.

### SUMMARY OF THE INVENTION

The invention disclosed herein overcomes some of the shortcomings of the prior art by disclosing a compact comb that additionally includes tools capable of performing functions unrelated to personal grooming Specifically, the embodiments disclosed herein are comprised of a compact comb combined with at least one additional tool chosen from the group consisting of: a screwdriver, a wrench, a bottle opener, a chip clip, a retention device and a positioning device. In this way, a user is able to comb his/her hair or the hair of another individual, pet, or fiber as well as perform additional functions such as tightening or loosening a screw, bolt, or nut; opening a bottle; storing elastic bands, hair bands, ear buds and the like; or creating a stand for a personal device, such as a phone or tablet.

In one embodiment, the inventors disclose a compact, multifunctional tool comprising a substantially flat, monolithic tool body wherein the monolithic tool body is further comprised of: a comb; and at least one tool formed in or on the monolithic tool body by a cutout or contour, wherein the at least one tool is chosen from the group consisting of a screwdriver, a wrench, a chip clip, a bottle opener, a retention device and a positioning device.

In an alternate embodiment, the monolithic tool body of the multifunctional tool of is formed of metal, plastic, wood, ceramic, carbon fiber, or rubber.

In yet an alternate embodiment, the monolithic tool body of the multifunctional tool is hardened.

In an alternate embodiment, the dimensions of the monolithic tool body of the multifunctional tool are less than about one and one half of the size of a credit card. In still another embodiment, the dimensions of the monolithic tool body of the multifunctional tool are less than about the size of a credit card.

In an additional embodiment, the comb is further comprised of a plurality of teeth, wherein the teeth have at least two different lengths.

In yet another embodiment, the comb is further comprised of a plurality of teeth, wherein the teeth are tapered such that at least two teeth are wider at a base than at a tip.

In an additional embodiment, the comb is further comprised of a plurality of teeth, wherein a first radius of curvature of one end of the teeth is different than a second radius of curvature at t second end of the teeth.

In still another embodiment, a configuration of the screwdriver is chosen from the group consisting of Phillips, slotted, quadrex, Pozidriv, square recess, square recess tamper resistant, Torx, tamper resistant Torx, Torx plus, tamper resistant Torx plus, hexagonal, tamper resistant hexagonal, Tri-Wing, Spanner, and one way removal tool.

In an additional embodiment, there is a first and a second wrench, wherein the first and second wrenches are of differing sizes.

In an alternate embodiment, a cutout formed in the monolithic tool body is of a size designed to accommodate a personal device.

In a different embodiment, the cutout is further comprised of an edge having a material chosen to enhance the coefficient of friction between the edge and the personal device.

In an additional embodiment, the chip clip is designed so that a retention slot narrows at an upper end.

In an alternate embodiment, the chip clip is designed so that a lower portion of the retention slot is wider than the upper portion of the retention slot.

An additional embodiment encompasses a method for forming a compact, multifunctional tool from a substantially flat monolithic body comprising using a cutting tool to cut a comb tine and at least one at least one tool formed in or on the monolithic tool body by a cutout or contour, wherein the at least one tool is chosen from the group consisting of a screwdriver, a wrench, a chip clip, a bottle opener, a retention device and a positioning device.

### BRIEF DESCRIPTION OF THE DRAWINGS

FIG. 1A is a front view of an embodiment of a compact multifunctional comb showing dimensional measurements of an embodiment.

FIG. 1B is a side view of a compact multifunctional comb showing a dimensional measurement.

FIG. 2 is a front view of a compact multifunctional comb showing various tools that could be combined with the comb to form a panoply of embodiments disclosed herein.

FIG. 3 is a perspective view of a compact multifunctional comb showing various tools that could be combined with the comb to form a panoply of embodiments disclosed herein.

FIG. 4 is a perspective view of a compact multifunctional comb showing an embodiment having a chip clip.

FIG. 5 is a perspective view of an embodiment of a compact multifunctional comb wherein the multifunctional comb comprises a positioning device.

### GLOSSARY OF REFERENCE NUMBERS

The following table contains a list of reference numbers used in the figures and specification attendant to the various embodiments of the present invention.

| Reference Number | Aspect of Embodiments |
|---|---|
| 200 | multi-functional tool |
| 202 | monolithic tool body |
| 204 | comb teeth |
| 206 | outer comb tooth |
| 208 | inner comb tooth |
| 210 | base of comb tooth |
| 212 | tip of comb tooth |
| 220 | screwdriver |
| 222 | first interior cutout |
| 224 | second interior cutout |
| 226 | chip clip |
| 228 | bottle opener |
| 232 | first notch |
| 234 | second notch |
| 310 | first flat edge |
| 312 | second flat edge |
| 410 | bag of chips |
| 510 | personal device |

### DETAILED DESCRIPTION

Those of skill in the art will recognize throughout this specification that when like terms are used to describe features and functionalities of various portions of a particular embodiment, those same features and functionalities could be present in additional embodiments having aspects with like terms.

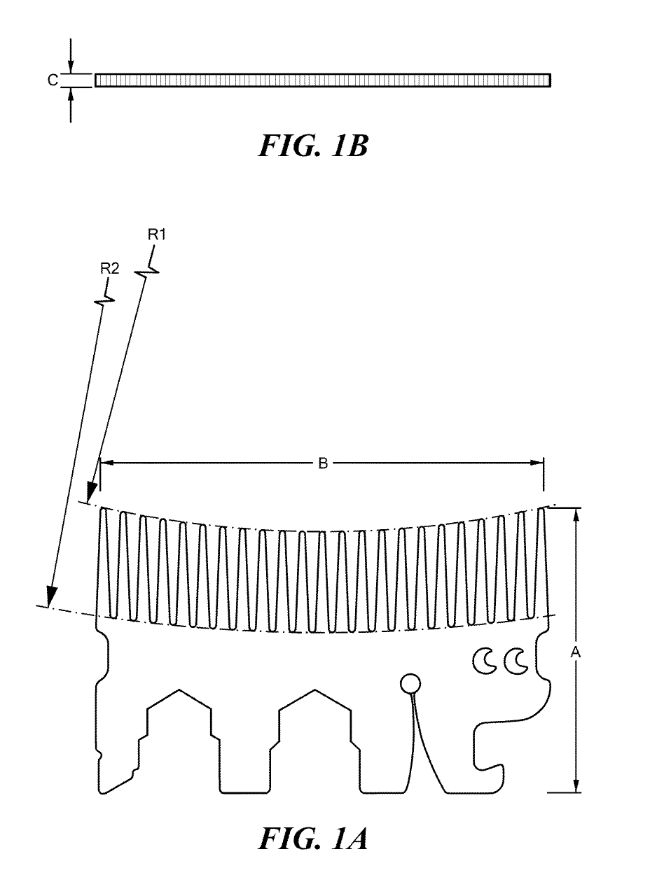

FIG. 1A shows an embodiment of the present invention wherein some of the dimensions of the compact, multifunctional tool are shown. In embodiments, the height, A, could vary from 40 mm to 68 mm, and the length, B, could range from 63 mm to 107 mm In preferred embodiments, the height and width could be less than the dimensions of a standard credit card, e.g., a credit card that complies with the ISO/IEC 7810 ID-1 standard. According to present size criteria for credit cards complying with ISO/IEC 7810 ID-1 standard, the dimensions of a standard credit card are 85.60×53.98 mm Embodiments of the present invention could, therefore, be less than 85.60×53.98 mm in length, B, and height, A.

FIG. 1A also shows a first radius of curvature R1 for the upper portion of the comb, and a second radius of curvature R2 for the base of the comb. In some embodiments, the first radius of curvature R1 is greater than the second radius of curvature R2. In these embodiments, it is desirable for the comb to be comfortable to the user. As such, R1 should match the curvature of the average user's scalp. Whereas R2 should be large enough to maintain strength in the body of the tool. Also in some embodiments, the tip of the comb teeth should have as large a radius of curvature as possible. To be most effective, the comb should have a high linear tooth density. Also, the teeth should have increasing thickness toward the base of the tooth in order for the tooth extrusion to be as strong in bending as possible. These factors dictate having a smaller radius of curvature between teeth at the base of the teeth, R2, than at the tip of the teeth, R1.

As can be seen from FIG. 1B, the compact, multifunctional tool is generally flat. Additionally, the thickness of the tool, shown as C in FIG. 1B, can vary from 0.5 mm to 2.0 mm Most preferably the thickness of the tool is approximately the same thickness as a standard credit card, specifically in the range of 0.8 mm to 1.3 mm

In certain embodiments, the compact, multifunctional tool could be made of metal (for example and without limitation, stainless steel, ferromagnetic steel, other purpose steels, gold, silver, copper, titanium, or aluminum), wood, plastic, ceramic, carbon fiber, or rubber. Some of these materials could in additional embodiments be subjected to treatment, such as hardening to further strengthen the compact tool. For example, certain forms of both stainless and general purpose steel can be heat treated by tempering the metal in a furnace to the critical temperature to change the molecular structure and then quenching to quickly cool the material and retain the modified molecular structure. In these embodiments, it is desirable to anneal the metal at a lower temperature in the furnace shortly after quenching to restore a certain amount of toughness and reduce the brittleness of the material.

In alternate embodiments, the metal can be “cold” worked, such as cold rolling sheet metal, to impart stress into the bulk of the material, which acts similarly to heat treatment in modifying the physical properties of the material. Proper selection of material is important so that the multifunctional tool can be used for the intended functions without sustaining plastic deformation, as is the case when the applied stress exceeds the yield strength of the material. Hardening the metal, such as with the techniques described above, can help by increasing the yield strength of the material.

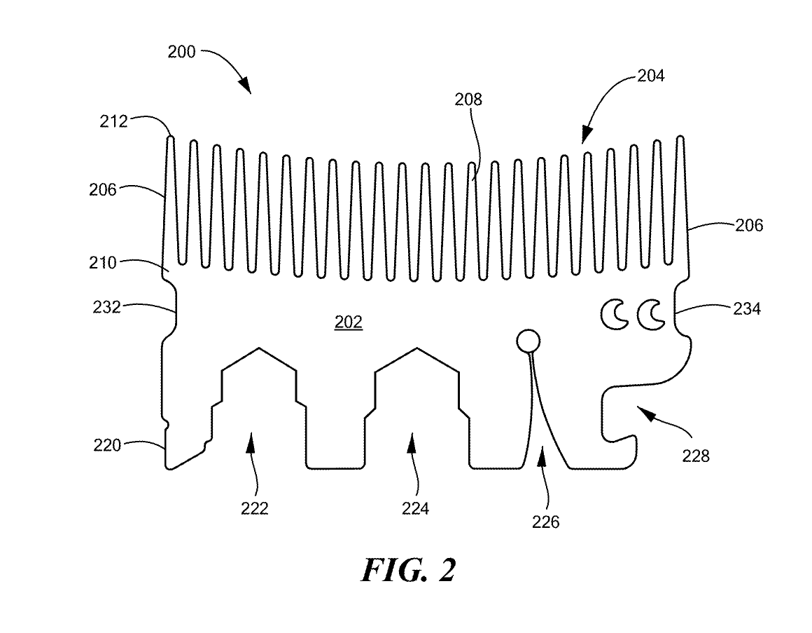

FIG. 2 shows an embodiment of the compact, multifunctional tool 200 comprising a comb 204 and a plurality of additional tools formed in or on the tool body 202. Previous attempts at making multifunction tools that include a comb required assembly of parts constructed using various manufacturing techniques, for instance, plastic injection molding and sheet metal stamping. This assembly increases cost, which can make the tool difficult to successfully retail, and reduces product strength, because the union between materials is inherently either weak or bulky.

The present embodiments overcome these previous limitations in the design of multifunction tools 200 that include a comb 204 by applying the construction concept of a monolithic body 202. This monolithic construction allows for the application of tools that require high-strength construction, such as a bottle opener 228, a wrench 222, 224, or a screwdriver 220, while keeping a low profile so that the multifunction tool 200 is easy to carry. It is inherently difficult to manufacture comb teeth 206, 208 where the spacing between teeth is small enough for the comb 204 to be highly functional, but yet not exceed the limits of the desired manufacturing process. For example, sheet metal stamping typically requires the geometry being removed to be a least twice the thickness of the sheet metal. This means there is either too great a distance between comb teeth 206, 208 for optimal use or the multifunction tool 200 is too weak for the other intended functions.

In one embodiment, the application of fine processes, such as laser cutting, allow for the present invention to achieve the desired balance between maximizing product strength and minimizing comb teeth spacing. In alternate embodiments, the cutting tool could be an electrical discharge machining (EDM), electro-chemical erosion, water jet cutting, or similar techniques known to those skilled in the art. In an alternate embodiment, the compact, multifunctional tool could be created by using a fine blanking stamping die to punch parts out of the sheet metal. In these embodiments, and others that are similar and known to those of skill in the art, the application of fine processes allows for precision edges, shapes, sizes, contours, and notches to be created thereby facilitating the operational and structural capabilities of the tools discussed herein.

Accordingly, in a method embodiment of the present invention, the method is comprised of forming a compact, multifunctional tool from a substantially flat monolithic body comprising using a cutting tool to cut a comb tine and at least one at least one tool formed in or on the monolithic tool body by a cutout or contour, wherein the at least one tool is chosen from the group consisting of a screwdriver, a wrench, a chip clip, a bottle opener, a retention device and a positioning device. In alternate methods, any of the multifunctional tools claimed herein could also be made by the using a cutting tool to cut any of the various tools, edges, cutouts, notches, or enclaves discussed n this specification and in the claims.

In terms of the sizing of the teeth, the outer teeth 206 are longer than the inner teeth 208 in some embodiments. This variation in size allows the comb 204 to flow smoothly over the rounded contours of people's heads. In alternate embodiments, perhaps designed for combing rugs or animals, the length of the outer teeth 206 could be substantially equally to the length of the inner teeth 208. In alternate embodiments, the teeth 206, 208 could be staggered to facilitate combing of wet, snarled, and/or pet hair. In these embodiments, every other tooth in the comb 204, for example, could be approximately half or three quarters of the height of an adjacent tooth.

Moreover, the base of the teeth 210 is wider than the tip of the teeth 212, which allows for great stability for each of the teeth 206, 208. In addition, the tip of the teeth 212 could be rounded or contoured in some other fashion in order to provide for a smooth and comfortable flow of the comb teeth 206, 208 through an individual's hair.

In some embodiments, the spacing between the comb teeth 206, 208 could vary depending upon whether the intended recipient of the combing function had thick hair, thin hair, or a coarse or fine weave between fibers. In some embodiments, spacing could be a function of the number of overall teeth 206, 208 in the comb 204, whereas in alternate embodiments spacing between the teeth 206, 208 could be a function of the width of the teeth 206, 208 and the overall length of the compact, multifunctional tool 200.

In addition to the comb 204, the compact, multifunctional tool also includes at least one tool formed in or on the tool body by a cutout or contour, wherein at least one tool is chosen from the group consisting of a screwdriver 220, a wrench 222 or 224, a chip clip 226, a bottle opener 228, a phone or tablet stand, a retention device that can be formed with a first notch 232 and a second notch 234. Embodiments of the compact, multifunctional tool could include a comb 204 and only one of the additional tools listed above. For example, an embodiment of the compact, multifunctional tool could include comb 204 and screwdriver 202. An alternate embodiment could include comb 204 and wrench 222. An alternate embodiment could include comb 204 and wrench 224. An alternate embodiment could include comb 204 and chip clip 226. An alternate embodiment could include comb 204 and wrench 222 or 224, wherein the wrench 222 cutout is customized to facilitate use of the cutout as a stabilizing plane for holding a personal device. An alternate embodiment could include comb 204 and bottle opener 228. An alternate embodiment could include comb 204 and retention device created by a first notch 232 and a second notch 234. Alternate embodiments could have any or all combinations of these tools formed on or in the tool body 202.

In terms of the tools shown in FIG. 2, in alternate embodiments, the screwdriver could have any one of the following head types as well as additional head types known to those of skill in the art: Phillips, slotted, alien key, quadrex, Pozidriv, square recess, square recess tamper resistant, Torx, tamper resistant Torx, Torx plus, tamper resistant Torx plus, hexagonal, tamper resistant hexagonal, Tri-Wing, Spanner, and one way removal tool. The size of the screwdriver head could also vary in alternate embodiments ranging from a very small screwdriver head designed to work with eyeglass screws to a much larger screwdriver head designed to accommodate household, car, bicycle, motorcycle, electronics, or any machine sized screw.

The wrenches 222 or 224 could be open-ended, as shown in FIG. 2, or closed-ended in alternate embodiments. In addition, the sizes of the wrenches 222, 224 could vary from embodiment to embodiment and the sizing could be metric, standard, or a combination thereof if a particular embodiment had two wrenches 222, 224.

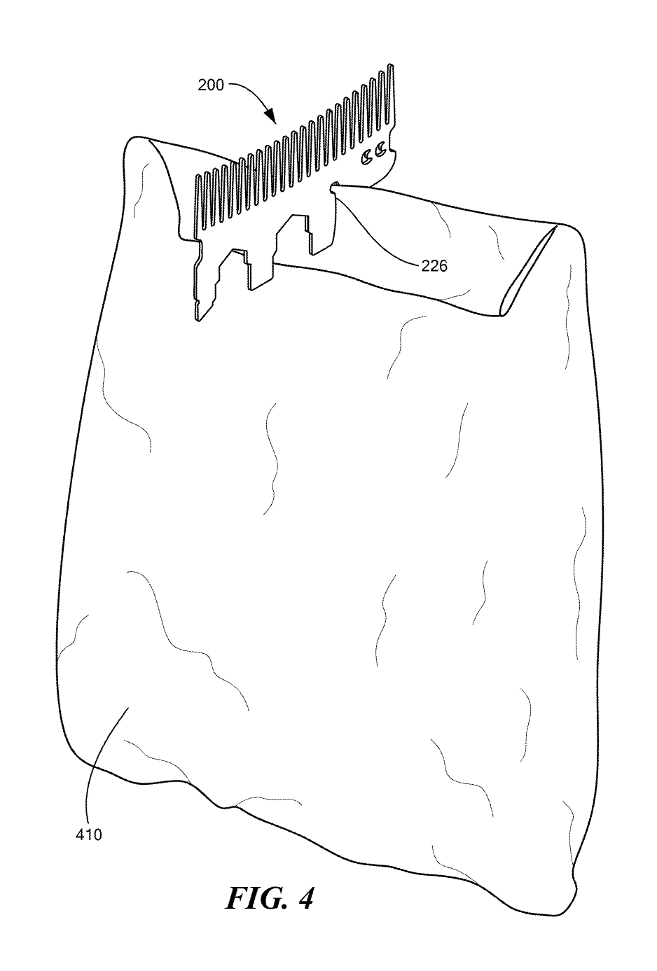

The chip clip 226 is essentially a clip that can be used to keep the contents of a bag fresher than would otherwise be the case without a clip to keep the open edges of the bag tightly folded. These types of items are well known by consumers and those skilled in the art and are often referred to as “chip clips” even though they can be used as a clip on a bag of fruits, vegetables, meats, cheeses, pastries, cookies, sandwiches, and so forth. FIG. 4 shows the compact, multifunctional tool being used as a chip clip 226 to securely close a bag of opened chips. Those of skill in the art will appreciate that the chip clip 226 of the present invention could be used to close a bag containing any type of goods, food or otherwise. For example, the chip clip 226 could be used to fasten a bag containing loose screws, paper clips, hardware of any sort, knobs, make-up, all manner of items that one may enclose within a bag. Accordingly, in alternate embodiments, the sizing of the chip clip 226 could vary to accommodate different bag types, for example bags made of: canvas, paper, cloth, vinyl, thin plastic, and so forth. In alternate embodiments, an adhesive or sticky material such as rubber could be placed inside of the chip clip 226 to enhance the ability of the chip clip 226 to form a tight seal when proximal to a bag.

In some embodiments, there may be a bottle opener 228. The bottle opener 228 could be formed on one end by the foot of an animal and on the other by the animal's chin In FIG. 2, the bottle opener 228 is formed by the foot and chin of a hedgehog. In alternate embodiments, the animal could vary and could for example, without limitation, be a porcupine, an echidna, a wolf, a fox, a tiger, a dog, a peacock, a flamingo, a bear, or any other two or four legged animal, or even human being.

In some embodiments, it may be desirable to personalize the compact, multifunctional tool 200 by having the face of the tool be a particular person, celebrity, super hero, historical figure, cartoon, avatar, movie character, or the like.

A retention device could also be included in alternate embodiments. With reference to FIG. 2, a retention device is created by a first notch 232 and a second notch 234. The retention device could be used to hold an item or a plurality of items in place. By way of example, the retention device could be used to hold hair bands, keys that are on an elastic band, ear buds, a charging cord, a work or other badge on a lanyard, a whistle, and the like. If the item contained elastic properties, a user could simply wrap the elastic around the first notch 232 and the second notch 234 until the elastic tightened thereby securing the item. If, however, the item did not have elastic properties, for example ear buds, the user could wrap the ear buds around the first notch 232 and the second notch 234 in the same way that one roles up a hose until the ear buds were completely wrapped around the first notch 232 and the second notch 234. The user could secure the ear buds by tucking one or both of them into the wrapped wire as s/he secured the ear buds to the monolithic tool body 202. Alternatively, the user could slide the ends of the ear buds between the comb teeth 204 and pull down until the friction between the sides of the teeth 204 and the cord was sufficient to pinch and hold the end firmly in place.

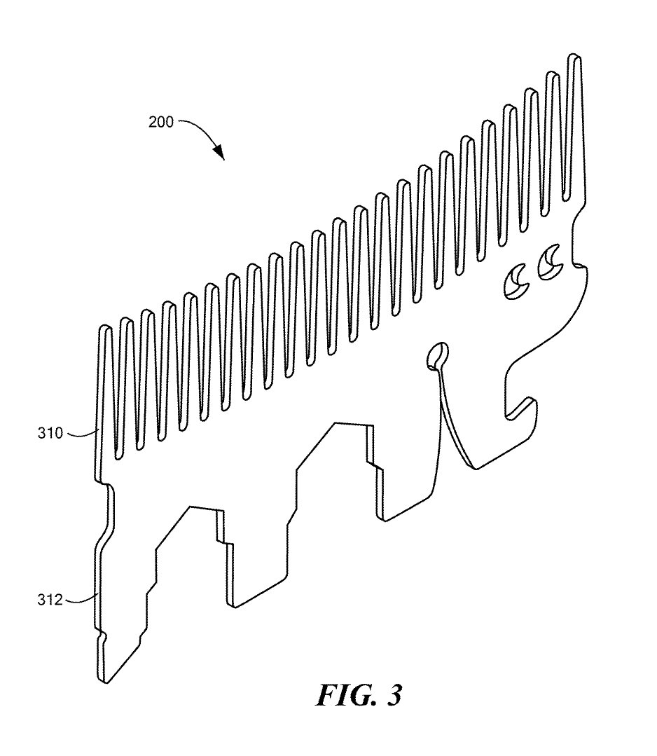

FIG. 3 depicts a perspective view of an embodiment of the invention. In this embodiment, the compact, multifunctional tool 200 includes a plurality of tools, e.g., a screwdriver 220, a first wrench 222, a second wrench, 224, a chip clip 226, a bottle opener 228, and a retention device formed by first notch 232 and second notch 234. FIG. 3 also shows a first flat edge 310 and a second flat edge 312. When the compact, multifunctional tool is rotated counterclockwise 90° and these flat edges 310, 312 are proximal to a solid surface of the compact, multifunctional tool 200, the compact multifunctional tool 200 can also be used as a stand for a personal device.

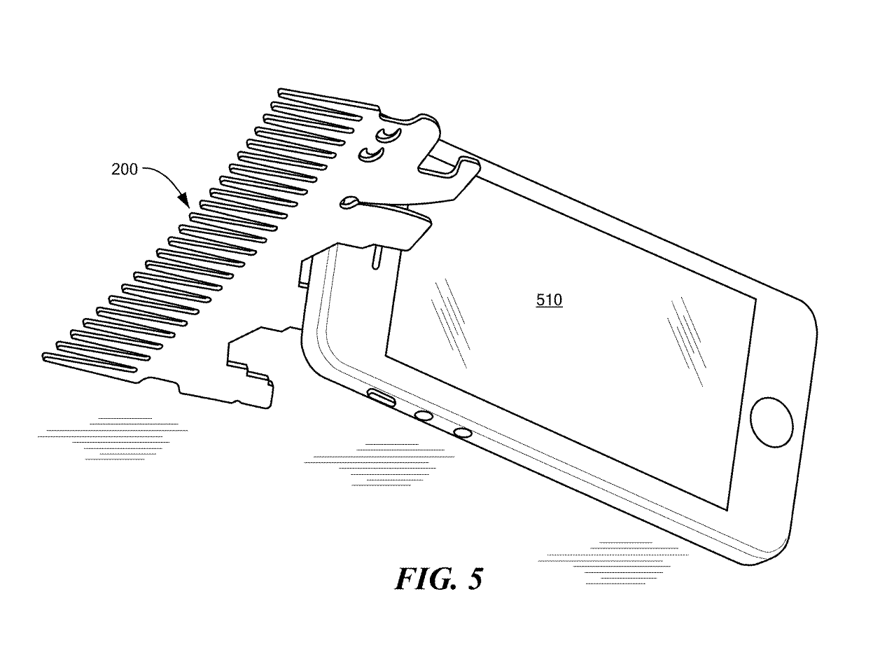

FIG. 5 depicts this aspect of the present invention. As can be seen in FIG. 5, when the first flat edge 310 and the second flat edge 312 are proximal to a flat surface, a stand is created wherein the stand can steadily secure a device 510. The device could be a mobile telephone, a tablet, a book, a magazine, or any other object for which it would be beneficial for the user to prop up for viewing, reading, drawing, editing, and the like. In embodiments of this nature, the cutouts could be specifically sized to accommodate various different devices or objects as mentioned above.

The cutouts could also include rubber edges or some other type of material affixed to the edges to better secure the specific device/object. If for example, a user desired to secure a hardcover book on a stand, the cutout could be deep enough to be able to accommodate a book. It may also include a small lip to help stabilize the book as well as rubber edges to help prevent slipping. In an alternate embodiment, designed to create a mobile phone stand, the cutout may be narrower in width and may include a rubber edge on all three sides to enhance stability of the contact point between the compact, multifunctional tool 200 and the mobile phone.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A compact, multifunctional tool comprising a substantially flat, monolithic tool body wherein the monolithic tool body is further comprised of:
a. a comb; and
b. at least one tool formed in or on the monolithic tool body by a cutout or contour, wherein the at least one tool further comprises at least one of a screwdriver, a wrench, a chip clip, a bottle opener, a retention device or a positioning device.

2. The compact, multifunctional tool of claim 1 wherein the monolithic tool body is formed of metal, plastic, wood, ceramic, carbon fiber, or rubber.

3. The compact, multifunctional tool of claim 2 wherein the monolithic tool body is hardened.

4. The compact, multifunctional tool of claim 1 wherein the dimensions of the monolithic tool body are less than about one and one half of the size of a credit card.

5. The compact, multifunctional tool of claim 1 wherein the dimensions of the monolithic tool body are less than about the size of a credit card.

6. The compact, multifunctional tool of claim 1 wherein the comb is further comprised of a plurality of teeth, wherein the teeth have at least two different lengths.

7. The compact, multifunctional tool of claim 1 wherein the comb is further comprised of a plurality of teeth, wherein the teeth are tapered such that at least two teeth are wider at a base than at a tip.

8. The compact, multifunctional tool of claim 1 wherein the comb is further comprised of a plurality of teeth, wherein a first radius of curvature of one end of the teeth is different than a second radius of curvature at t second end of the teeth.)

9. The compact, multifunctional tool of claim 1 wherein a configuration of the screwdriver is chosen from the group consisting of Phillips, slotted, quadrex, Pozidriv, square recess, square recess tamper resistant, Torx, tamper resistant Torx, Torx plus, tamper resistant Torx plus, hexagonal, tamper resistant hexagonal, Tri-Wing, Spanner, and one way removal tool.

10. The compact, multifunctional tool of claim 1 comprising a first and a second wrench, wherein the first and second wrenches are of differing sizes.

11. The compact multifunctional tool of claim 1 wherein a cutout formed in the monolithic tool body is of a size designed to accommodate a personal device.

12. The compact, multifunctional tool of claim 11 wherein the cutout is further comprised of an edge having a material chosen to enhance the coefficient of friction between the edge and the personal device.

13. The compact, multifunctional tool of claim 1 wherein the chip clip is designed so that a retention slot narrows at an upper end.

14. The compact, multifunctional tool of claim 13 wherein the chip clip is designed so that a lower portion of the retention slot is wider than the upper portion of the retention slot.

15. A method for forming a compact, multifunctional tool from a substantially flat monolithic body comprising using a cutting tool to cut a comb tine and at least one at least one tool formed in or on the monolithic tool body by a cutout or contour, wherein the at least one tool further comprises at least one of a screwdriver, a wrench, a chip clip, a bottle opener, a retention device or a positioning device.
